(19) United States
(12) Patent Application Publication
(10) Pub. No.: US 2010/0159817 A1
(43) Pub. Date: Jun. 24, 2010

(54) Ventilation Device and Window Comprising Such a Device

(76) Inventor: Claes Lindgren, Farum (DK)

Correspondence Address: MEREK, BLACKMON & VOORHEES, LLC, 673 S. WASHINGTON ST, ALEXANDRIA, VA, 22314, US

(21) Appl. No.: 11/990,202

(22) PCT Filed: Sep. 5, 2006
(86) PCT No.: PCT/DK2006/000492

§ 371 Date: Feb. 8, 2008

(30) Foreign Application Priority Data
Sep. 5, 2005 (EP) 05388075.3

(51) Int. Cl. E06B 7/10

(52) U.S. Cl. 454/211

(57) ABSTRACT

The ventilation device (10) comprises a first plate (11) having a first set of apertures (16), and a second plate (21) having a second set of apertures (26) separated by cover portions (27). The first and second plates are slidable with respect to each other. The cover portions (27) have dimensions differing from the dimensions of the first set of apertures (16). Furthermore, the dimensions of the cover portions vary along said first direction (x) and/or in a second direction (y) perpendicular to the first direction to provide a visual indication of the degree of ventilation area achieved.

The present invention relates to a ventilation device comprising: a first plate having a first set of apertures, and a second plate having a second set of apertures separated by cover portions, said first and second plates being slidable with respect to each other in a first direction between a first and a second extreme position and being able to assume at least one intermediate position between said extreme positions, in which first extreme position all apertures of said first set are aligned with said cover portions and not with the apertures of said second set, and in which second extreme position all apertures of said first set are at least partially aligned with the apertures of said second set.

Ventilation devices of this type comprising two mutually sliding plates are also denoted registers or sliding vents. Such devices are well known in the art and are traditionally built into building structures such as windows and doors. Examples are disclosed in e.g. DE 30 34 765 A1, DE 1 208 864 A and U.S. Pat. No. 5,581,945. Such sliding devices have the advantage that a translational movement in only one direction is able to provide different airflows through the device. The construction of the device can thus be kept simple and compact and is easy to operate.

In the simplest form of the prior art ventilating device, the apertures of the two plates of the ventilation device have corresponding dimensions. Furthermore, the dimensions of the first set of apertures most often correspond to those of the cover portions of the second plate. In this manner, it is possible to move the ventilation device between the closed position and the fully open ventilating position corresponding to the total area of the apertures in the first plate without having to slide the plates excessively with respect to each other. The total ventilating area increases linearly as the plates are slid with respect to each other. In other words a relationship exists between the ventilating area and the relative distance traveled by the plates.

In this configuration of a ventilation device it is not possible or at the very least difficult for a user to determine the size of the ventilating area and thereby the flow of air through the device. As a consequence users tend to utilise only the extreme positions of the device, i.e. the closed and the fully open ventilating positions, the latter position being the one in which the apertures of the first plate are completely free of the cover portions of the second plate, whereas the intermediate positions are not utilised. The fully open position may for some users be experienced as too cold and/or draughty, and they tend to close the ventilation device completely. In many fields of application of such a building structure, however, it is highly desirable to have at least some minimum degree of ventilation.

These problems have not been solved by any of the above-mentioned prior art ventilation devices.

It is an object of the invention to provide a ventilation device of the initially stated kind, which provides for a better visual indication of the intermediate position(s) of the first and second plates of the ventilation device.

This object is achieved by means of a ventilation device of the initially stated kind, which is characterized in that the dimensions of said cover portions vary along said first direction and/or along a second direction perpendicular to the first direction such that in said intermediate position at least one aperture of said first set is at least partially aligned with at least one aperture of said second set, and at least one other aperture of said first set is aligned with a cover portion and not with an aperture of said second set

When a ventilation device of the generally described prior art type is build into a building structure, the first or the second plate is typically positioned toward the inside of the building and the remaining plate is positioned toward the outside. Generally speaking, if the area of an aperture is halved, the human eye is normally not capable of determining this or even noting a difference from the amount of light shining through the aperture. If light (e.g. sun light) is allowed to shine through a prior art ventilation device, it is thus not possible or very difficult for a user to determine if the device is in an intermediate position or in the completely open position. Only when the ventilating area becomes very small (or is closed), it is possible to determine any decrease of the intensity of light. A small amount of light (e.g. from a neighbouring house or a street light) shining through an aperture is usually enough to “blind” the human eye such that the second plate will not be visible from the inside when in an intermediate position, and the mutual positions of the plates cannot be determined by a user from the inside of the building structure.

By the arrangement of the cover portions of the ventilation device according to the invention it has proven possible to provide intermediate ventilating positions, which are visually indicated to and very easy to notice by a user. This is due to the fact that in at least one intermediate position one aperture will be closed and one will be open. It is very easy to determine that the closed aperture is closed because no light shines through it, i.e. it will be dark. Similarly, the open aperture is also very easy to determine because light shines through it, i.e. it will be luminous. With one aperture closed and one open, an intermediate position is thus achieved which is very easy to determine by a user, and in which the ventilating area is at an interval between the two extreme positions of the plates.

The relationship between the sliding movement and the total ventilating area may be varied by a suitable configuration of the cover portions relative to the apertures of the first plate.

In principle, the apertures of the first plate may be formed in any suitable manner. However, the first set of apertures is preferably positioned in uniformly spaced rows, each row extending in the second direction of the first plate. This makes it possible to form the first plate as a standard part and to provide the second plate in a variety of configurations according to the ventilating pattern desirable. Advantageously, each row comprises one or more apertures having a substantially rectangular, oval or circular form.

In an embodiment, which is particularly simple to manufacture, each of said cover portions is substantially rectangular, the width of said cover portions varying along the first direction. In this manner, the relationship between the total ventilating area and the relative distance traveled by the plates describes a curve. At the same time the user obtains a visual indication of the differing widths of the cover portions.

The width of the cover portions may increase or decrease from one end of the second plate along the first direction, which provides a total ventilating area forming a gradually decreasing or increasing curve as the plates are slid with respect to each other.

Alternatively, the width increases or decreases from both ends of the second plate. This provides for a bell-shaped curve having its minimum or maximum somewhere at the middle. Depending on the configuration, it is also possible to obtain different ventilating patterns if the plates are moved in one or the other direction.

In order to obtain more visible changes of the ventilating area as the plates are slid, each of said cover portions may be substantially triangular, the width of the cover portions varying along the second direction.

The substantially triangular shape may be formed by varying the width of the cover portions in a stepped or jagged pattern.

Whereas all of the above embodiments result in a ventilating area forming a more or less continuous curve as the plates are slid with respect to each other, it is also possible to have an arbitrary ventilating area as a result of the movement of the plates. In an alternative embodiment, the cover portions have mutually different forms.

In a further aspect of the invention a window comprising a ventilation device is provided.

The invention will be described in further detail with reference to the accompanying drawings, in which

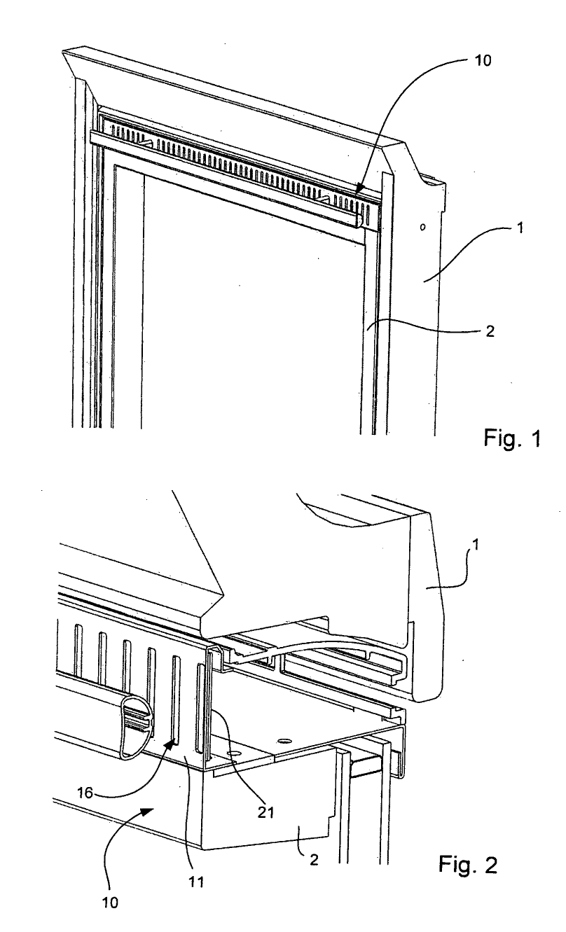

FIG. 1 shows a front view of a window with a ventilation device according to the invention;

FIG. 2 shows, on a larger scale, a cross-sectional view along the line II-II of FIG. 1;

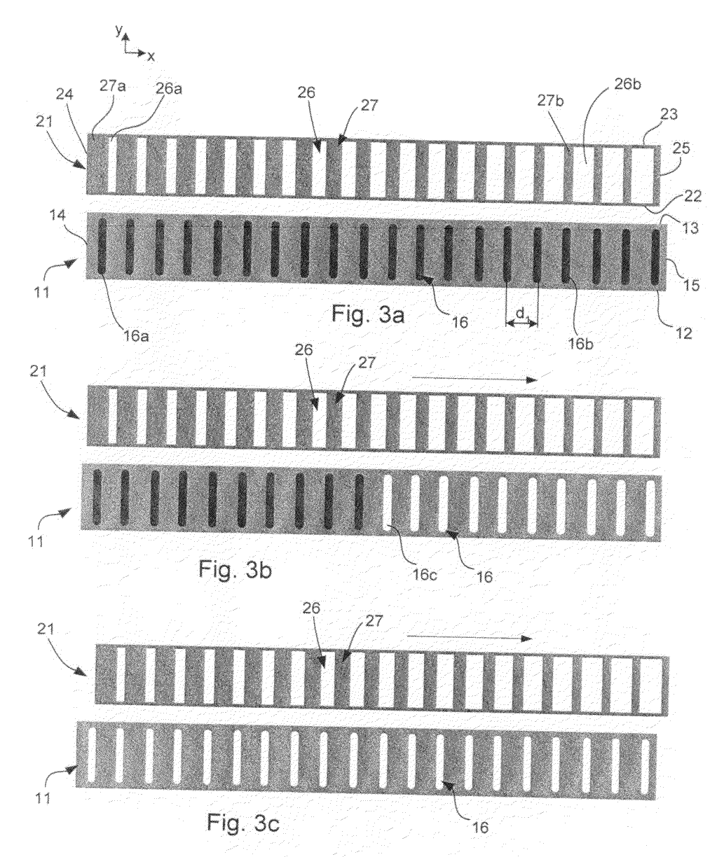

FIGS. 3a to 3c show plan views of an embodiment of two plates of the ventilation device of FIG. 1 in a first extreme position, an intermediate position and a second extreme position, respectively; and

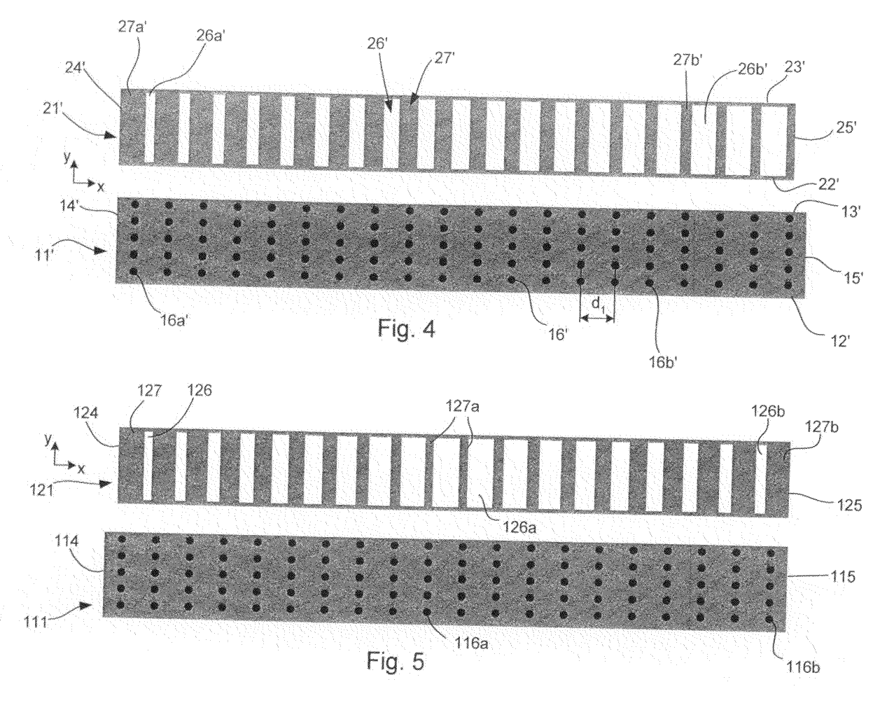

FIGS. 4 to 11 show plan views of different embodiments of two plates of a ventilation device according to the invention.

FIG. 1 shows a window of the kind having a frame 1 and a sash 2. In the sash a ventilation device 10 is mounted such that air may pass from the outside to the inside, or vice versa, when the ventilation device is in a ventilating position. The ventilation device 10 may be mounted in any suitable part of any building structure other than a window, such as a door.

As shown most clearly in FIG. 2, the ventilation device 10 comprises two plates 11 and 21, of which the first plate 11 is connected in a stationary manner with the sash 2. The first plate 11 has a first set of apertures 16 formed as transversely extending slits. The second plate 21 is slidably connected with the first plate 11 by appropriate guide means accommodating longitudinally extending side edges 22 and 23 of the second plate 21, cf. FIG. 3. Furthermore, the ventilation device 10 is provided with operating means. Such operating means may be manual and comprise e.g. a handle (not shown) connected with the second plate 21. However, the operating means may assume more elaborate forms including electrically operated mechanisms moving the second plate 21 in response to e.g. sensing means or remote control means.

With reference to FIG. 3a the first plate 11 is formed as a substantially rectangular plate of any suitable material, e.g. aluminium. The first plate 11 has its longer side edges 12, 13 extending in the first direction x, in the embodiment shown the longitudinal direction of the ventilation device, and shorter end edges 14, 15 extending in a second direction y perpendicular to the first direction, i.e. here the transverse direction. The first plate 11 is provided with a first set of apertures 16 formed as oblong apertures positioned in a row extending in the longitudinal direction x of the first plate 11 substantially from one edge 14 to the other 15, each aperture 16 extending in the transverse direction y substantially from one edge 12 to the other 13. The distance between two adjacent apertures 16 is denoted d₁. These apertures may instead of rectangular, circular or oval shape. The apertures are formed in any suitable manner and may e.g. be punched out of the plate.

The second plate 21 is provided with a second set of apertures 26 separated from each other by cover portions 27. In the embodiment shown in FIGS. 3a to 3c the cover portions 27 all have a substantially rectangular shape, the width of the cover portions 27 decreasing from the left-hand end edge 24. As a consequence of this configuration, the width of the second set of apertures 26 and thereby the aperture area increases from left to right. In the embodiment shown, the cover portions 27 are configured in such a manner that all of the apertures 16 are covered in a first extreme position shown in FIG. 3a. That is, the second plate 21 has cover portions 27 at positions corresponding to the distance d1 of the first plate 11. However, it is also conceivable to form the plates in such a manner that some apertures of the first plate are uncovered in all positions of the ventilation device. Furthermore, it should be noted that all directional indications such as “right”, “left”, “up”, “down” etc. are purely arbitrary. The ventilation device may be mounted in any suitable manner in the building structure.

When operating the ventilation device, the second plate 21 is slid along the longitudinal direction x. In FIG. 3a two arbitrary apertures 16a and 16b of the first plate 21 have been marked. In the closed position shown, these apertures are covered by cover portions 27a and 27b, respectively. If the second plate 21 is slid a short distance only to the left, the right-hand aperture 16b will move free of the cover portion 27b and into alignment with aperture 26b. In this position, the left-hand aperture 16a is still covered by cover portion 27a. By further movement of the second plate 21, this aperture 16a also moves free of its correspondent cover portion 27a and into alignment with aperture 26a.

When this position has been reached, the total ventilating area provided by the aligned apertures 16 and 26 has arrived at its maximum value corresponding to the total area of the apertures 16. The operation of the ventilation device 10 is explained in further detail in the following with reference to FIGS. 3a to 3c.

In FIGS. 3a to 3c the ventilation device 10 is positioned in a window or another building structure such that the first plate 11 is positioned toward the inside of the building, and light from the outside shines through any apertures 16 not covered by the cover sections 27 of the second plate 21.

At the upper parts of each of FIGS. 3a to 3c the second plate 21 is shown by itself. At the lower parts the first plate 11 is shown with the second plate 21 hidden behind it such that some apertures are blackened or dark depending on if they are covered by a cover portion 27. FIG. 3a shows the plates 11, 21 in a first extreme position in which the apertures 16 are not aligned with the apertures 26, i.e. ventilation through the apertures is substantially completely prevented. As can be seen, the second plate 21 is in a position in relation to the first plate 11 in which none of the apertures 16 are aligned with the apertures 26, i.e. the cover portions 27 are aligned with and thus completely cover the apertures 16. All apertures 16 are thus blackened or dark in FIG. 3a.

In FIG. 3b the second plate 21 has been sled a small distance to the right in the figure in the direction of the arrow in order to assume an intermediate position. In this intermediate position about half the apertures 16 are at least partly out of alignment with the cover sections 27 such that they are now each aligned with one of the apertures 26. The other half are still out of alignment with the apertures 26. As was described in the above, even a small partly alignment of an aperture 16 with an aperture 26 will make the aperture 16 as light to the human eye as a complete alignment of the apertures 16, 26. This is the case for example of aperture 16c in FIG. 3b. A different easy-to-determine intermediate position and corresponding ventilating area is available for each aperture 16. Only small variations of the ventilating area exist for each of these intermediate positions.

In FIG. 3c the second plate 21 has been sled a further distance in the direction of the arrow in order to assume the second extreme position. In this position all the apertures 16 are at least partly out of alignment with the cover sections 27 such that they are now each at least partly aligned with one of the apertures 26. The ventilating area and thus the air flow through the ventilation device 10 are thus at their highest in this position.

The apertures 16 have a small extent in the longitudinal direction x due to the above-described fact that only a small amount of light will make it appear as if an aperture is completely open.

A modification of the embodiment of FIGS. 3a to 3c is shown in FIG. 4. Elements having the same or analogous function carry the reference numerals of FIGS. 3a to 3c to which a mark (') has been added. Only elements different from the embodiment of FIGS. 3a to 3c will be described.

The embodiment of FIG. 4 is different from FIGS. 3a to 3c in that the apertures 16′ of the first plate 11′ are shorter in the transverse direction of the plate 11′ such as to be of a circular shape. This allows for the provision of four rows of apertures 16′ in the transverse direction as opposed to only one row of oblong apertures 16 in the embodiment of FIGS. 3a to 3c. Such an embodiment of the first plate allows for a larger array of visualizing possibilities since it is possible also to visualize the sum of the areas of the open (i.e. aligned) apertures of the two plates also in the transverse direction. This is done by varying the dimensions of the apertures of the second plate in the transverse direction as will be apparent from the description of the embodiments of FIGS. 7 to 10.

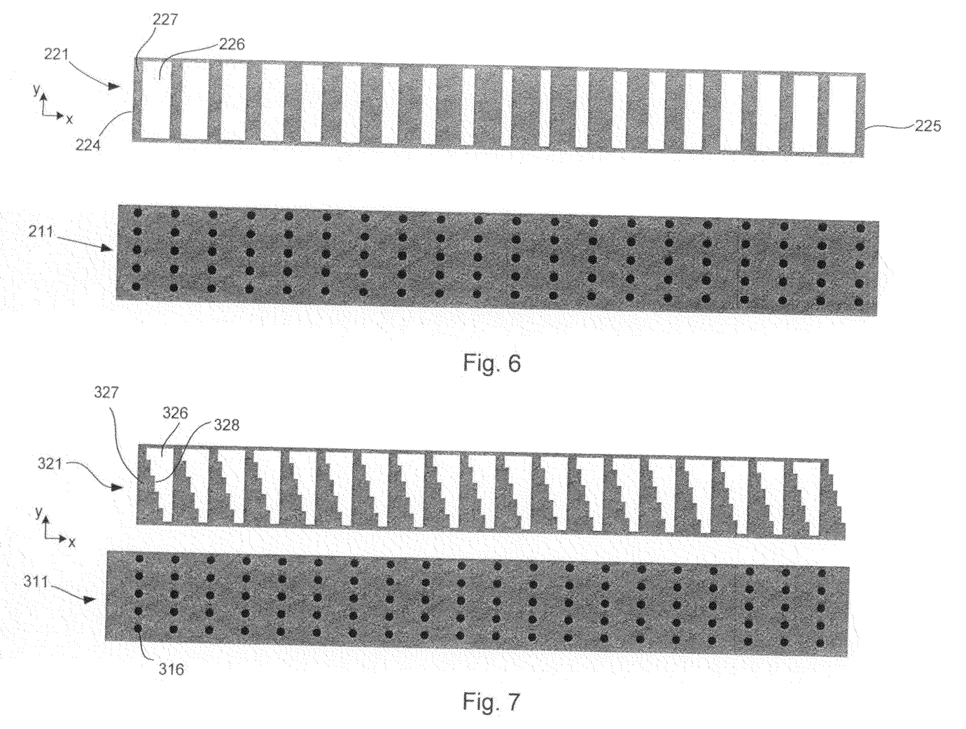

Two modifications of the embodiment of FIG. 4 are shown in FIGS. 5 and 6, respectively. Only differences from the embodiment of FIG. 4 will be described in detail. Elements having the same or analogous function carry the reference numerals as in FIGS. 3a to 3c to which 100 and 200, respectively, have been added. This applies, mutatis mutandis, to embodiments to be described further on.

In the embodiment of FIG. 5, the width of the cover portions 127 decrease from each end edge 124 and 125 such that the cover portions 127a near the centre of the second plate 121 are the narrowest. Correspondingly, the width of the apertures 126 increases towards the centre.

In the position shown in FIG. 5, cover portions 127 cover all apertures 116 of the first set. By sliding the second plate 121 slightly to the left, central apertures 116a move free of cover portion 127a and into alignment with aperture 126a. The apertures near the end edges 114, 115 of the first plate 111 are still covered, e.g. apertures 116b covered by cover portion 127b. By continued sliding to the left, all apertures 116 move free of their corresponding cover portions. Is the second plate 121 slid slightly to the right, however, all apertures 116 move into alignment with a corresponding aperture 126 of the second plate 121.

This applies in a corresponding manner to the embodiment of FIG. 6, in which the width of the cover portions increases from the end edges 224, 225 towards the centre.

In the embodiments of FIGS. 7 to 9, the first plate corresponds to the first plate of each of the above embodiments. As before, the second plate is provided with a set of apertures separated by cover portions. However, the cover portions are substantially triangular, i.e. the dimensions vary in the transverse direction. The operation of a ventilation device incorporating a plate having such substantially triangular cover portions will be described with reference to the embodiment of FIG. 7.

FIG. 7 shows the closed position of the ventilation device in which all of the apertures 316 are covered by corresponding cover portions 327. When the second plate 321 is slid slightly to the left, the upper apertures of the rows move free of the cover portion. For instance, the upper aperture of the left-hand row moves free simultaneously with the other rows of the first plate 311 as the second plate 321 is slid relative to the first plate 311. Continued movement of the second plate 321 entails that the apertures move free one after the other in each row, downwards in the transverse direction.

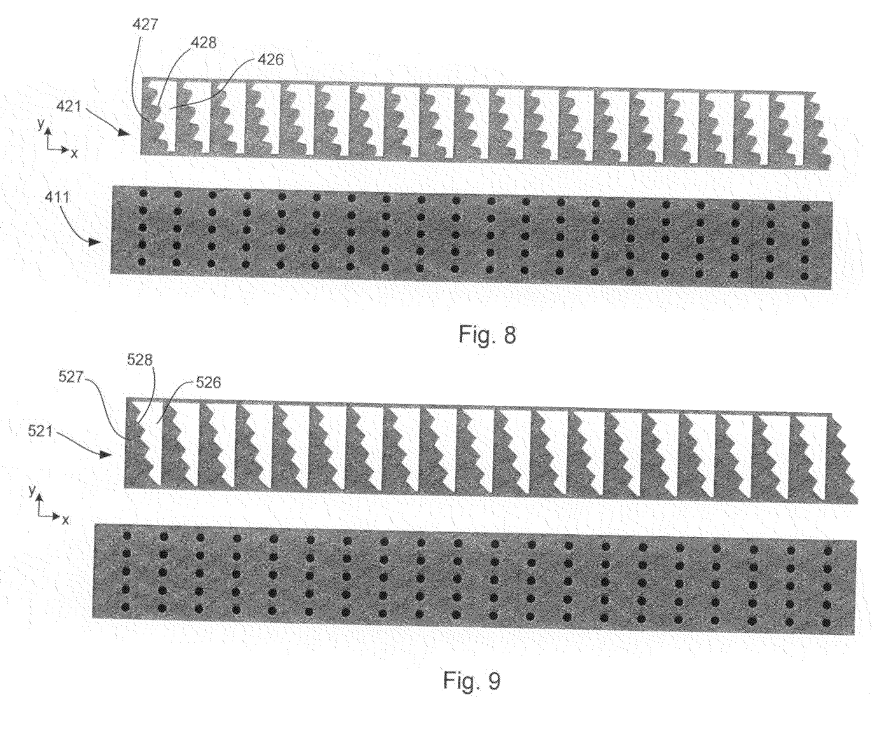

The same applies to the embodiments of FIGS. 8 and 9.

The edge 328 of each triangular-shaped cover portion 327 may be stepped as shown in FIG. 7, or comprise indentations 428 and 528 to form a jagged edge.

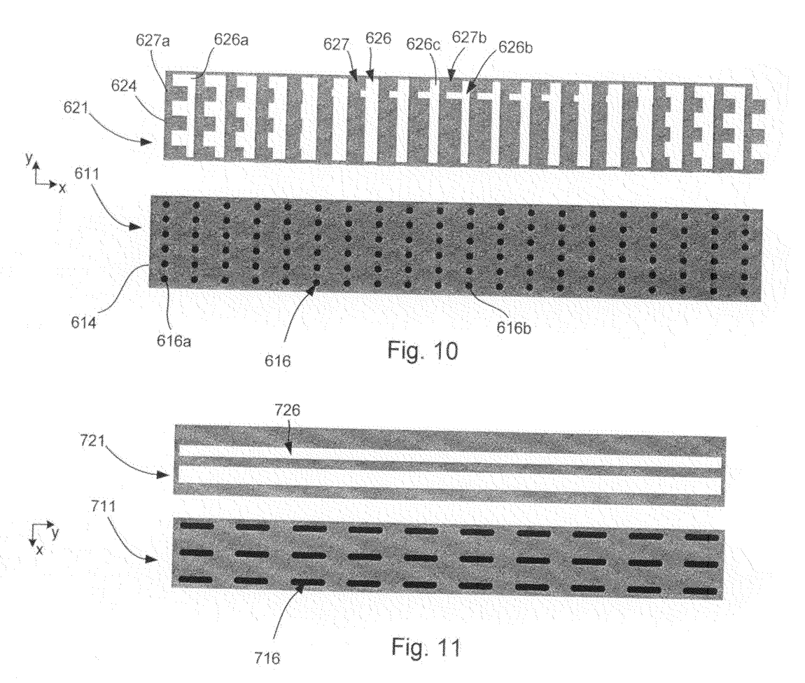

If it is desirable to have an arbitrary ventilating area as a result of the movement of the plates, the cover portions may be configured to have mutually different forms. Such an embodiment is shown in FIG. 10.

As in the above embodiments, the first plate 611 has its set of apertures 616 configured in rows, of which one row 616a near the left-hand end edge 614 and one row 616b at the centre of the plate 611 are indicated in FIG. 10.

The second plate 621 has the overall form of a punched card with apertures 626 separated by cover portions 627 forming cams which free the apertures of the first plate according to a predetermined pattern as the second plate is moved relative to the first plate. Two cover portions and three apertures are indicated in FIG. 10, viz. cover portion 627a and aperture 626a near the left-hand end edge 624, and cover portion 627b and apertures 626b and 626c near the centre of the second plate 621.

Moving the second plate 621 from the position shown in FIG. 10 slightly to the left, the first, third and fifth, counting from the top, apertures of the left-hand row 616a move free of the cover portion 627a and into alignment with the aperture 626a. In central row of apertures 616b the second aperture from the top is moved into alignment with the opening 626b. Correspondingly, the remaining parts of the plates 611 and 621 have been brought into a position forming a pattern of ventilating passages. This pattern is changed during the continued movement of the second plate 621. The resulting total ventilating area changes along a discrete graph relative to the distance traveled by the second plate in the longitudinal direction.

If the second plate 621 is moved slightly to the right, all the apertures 616 move free of their corresponding cover portions 627 and into alignment with apertures 626.

All of the above-described embodiments are configured for sliding the first plate in the longitudinal direction of the second plate in order to move the plates between the two extreme positions of the ventilation device. However, embodiments in which the first plate moves in the transverse direction of the second plate should also be considered as falling within the scope of the present invention. An example of such an embodiment is shown in FIG. 11. The first plate 711 comprises three rows of apertures 716, extending and being oblong in the longitudinal direction of the plate 716. The second plate 721 comprises only two apertures 726 extending in substantially the entire length of the plate 721. When changing the mutual positions of the plates 711, 721 between the two extreme positions, the first plate 711 is moved downwards in the direction x in relation to the second plate 721.

The invention should not be regarded as being delimited to the embodiments shown and described in the above. The varying dimensions in the longitudinal and/or transverse directions have been described as applying to the second plate only. It is also possible to vary the configuration of the apertures of the first plate. Furthermore, the first plate is in some embodiments described as stationary with respect to the building structure, be it a frame or sash of a window or a door, whereas the second plate is described as the movable part, or vice versa. Obviously, it is possible to interchange the first and second plates, or to make both plates movable with respect to the building structure.

1. A ventilation device (10) comprising:
a first plate (11) having a first set of apertures (16), and
a second plate (21) having a second set of apertures (26) separated by cover portions (27),
said first and second plates (11, 21) being slidable with respect to each other in a first direction (x) between a first and a second extreme position and being able to assume at least one intermediate position between said extreme positions,
in which first extreme position all apertures (16) of said first set are aligned with said cover portions (27) and not with the apertures (26) of said second set, and
in which second extreme position all apertures (16) of said first set are at least partially aligned with the apertures (26) of said second set,
characterized in that
the dimensions of said cover portions vary along said first direction and/or along a second direction (y) perpendicular to the first direction such that in said intermediate position at least one aperture (16) of said first set is at least partially aligned with at least one aperture (26) of said second set, and at least one other aperture (16) of said first set is aligned with a cover portion (27) and not with an aperture (26) of said second set.

2. A ventilation device according to claim 1, characterized in that said first set of apertures (16) is positioned in uniformly spaced rows, each row extending in the second direction of the first plate.

3. A ventilation device according to claim 2, characterized in that each of said cover portions (27) is substantially rectangular, the width of said cover portions varying along the first direction of the second plate (21).

4. A ventilation device according to claim 3, characterized in that the width increases or decreases from one end (24) of the second plate (21) along the first direction (x).

5. A ventilation device according to claim 4, characterized in that the width increases or decreases from both ends of the second plate.

6. A ventilation device according to claim 2, characterized in that each of said cover portions is substantially triangular, the width of the cover portions varying along the second direction.

7. A ventilation device according to claim 6, characterized in that the width of the cover portions varies in a stepped or jagged pattern.

8. A ventilation device according to claim 2, characterized in that the cover portions have mutually different forms.

9. A ventilation device according to claim 2, characterized in that each row comprises one or more apertures having a substantially rectangular, oval or circular form.

10. A ventilation device according to claim 1, characterized in that the ventilation device is provided with operating means in the form of electrically operated mechanisms providing a mutual movement of the first and second plates in response to sensing means or remote control means.

11. A window comprising a frame and a sash, characterized in that a ventilation device as claimed in claim 1 is mounted on the frame or the sash.
